(19) United States
(12) Patent Application Publication
(10) Pub. No.: US 2008/0244519 A1
(43) Pub. Date: Oct. 2, 2008

(54) Identifying, Correcting and Displaying Application Website and Device Compatibility Issues

(75) Inventors: Michael Anthony Sciacqua, North Bend, WA (US); Suma SaganeGowda, Woodinville, WA (US); Tri Minh Hua, Seattle, WA (US); Magdi Morsi, Bellevue, WA (US); Yevgeniya Ross, Redmond, WA (US); Stephen Edward Kreyenbuhl, Bothell, WA (US); Jee Fung Pang, Woodinville, WA (US); Chi F. Chen, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/694,294

(22) Filed: Mar. 30, 2007

(51) Int. Cl. G06F 9/44

(52) U.S. Cl. 717/120; 715/781; 717/168

(57) ABSTRACT

A method of identifying, correcting and displaying application website and device compatibility issues is disclosed. An agent framework is started that host compatibility agents. The compatibility agents are used to analyze an operating system user such as a device, an application or an update. The results of the compatibility agents are communicated to a database and the results of the compatibility agents are displayed using a user interface.

### BACKGROUND

This Background is intended to provide the basic context of this patent application and it is not intended to describe a specific problem to be solved.

As computers have become more complex, the ability to ensure that applications, hardware, devices and updates work together also has become more complex. Related, the many computers on a network may have different applications, hardware and devices and all may react differently to changes. Often, the results of changes cannot be predicted until the change is made. Further, if there is a problem, seldom is a solution provided to address the problem. Finally, there is no way to centrally review the compatibility issues of the computers on a network.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A method of identifying, correcting and displaying application website and device compatibility issues is disclosed. An agent framework is started that host compatibility agents. The compatibility agents are used to analyze an operating system user such as a device, an application or an update. The results of the compatibility agents are communicated to a database and the results of the compatibility agents are displayed using a user interface.

### DRAWINGS

FIG. 1 is a block diagram of a computing system that may operate in accordance with the claims;

FIG. 2 is a flowchart of a method of identifying and correcting application website and device compatibility issues;

FIG. 3 is an illustration of a sample design of the components of a sample compatibility application;

FIG. 4 is an illustration of how a sample application will proceed;

FIG. 5 is an illustration of a sample application report;

FIG. 6 is an addition window that may be displayed when a specific application in FIG. 5 is selected;

FIG. 7 is an illustration of a display when a computer tab is selected from the quick report section;

FIG. 8 is an illustration of a display when a device tab is selected from the quick report section; and

FIG. 9 is an illustration of a display when a particular device from FIG. 8 is selected.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

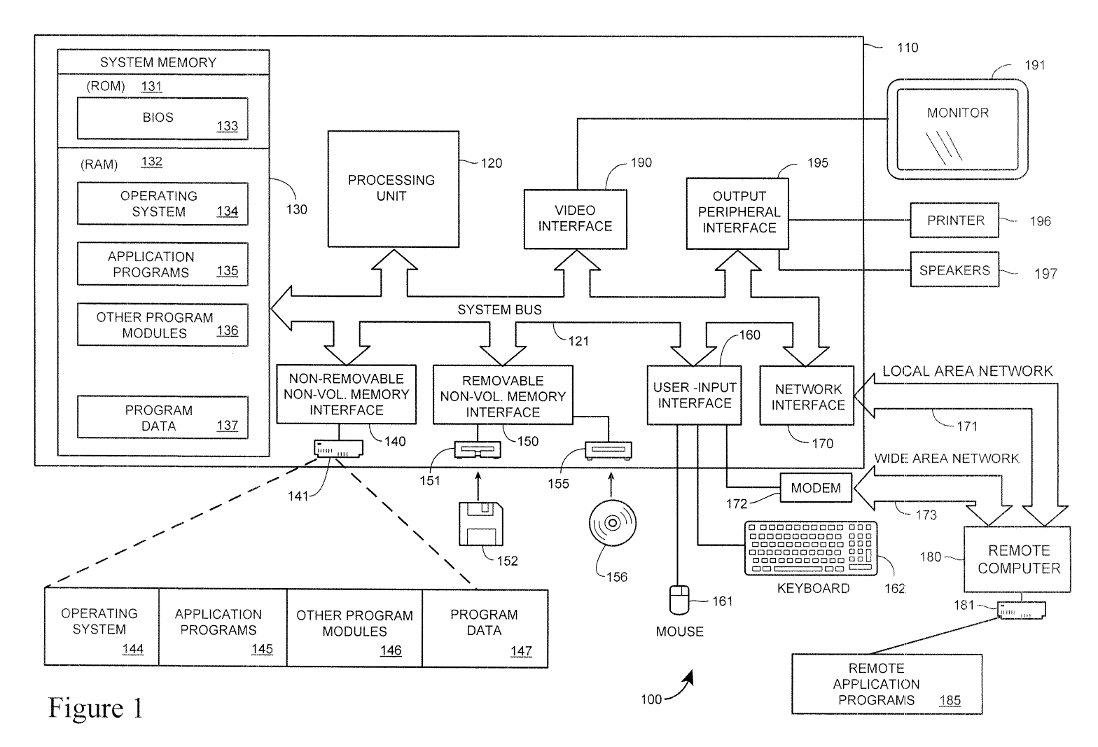

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and the Peripheral Component Interconnect-Express (PCI-E).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131 RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173 but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

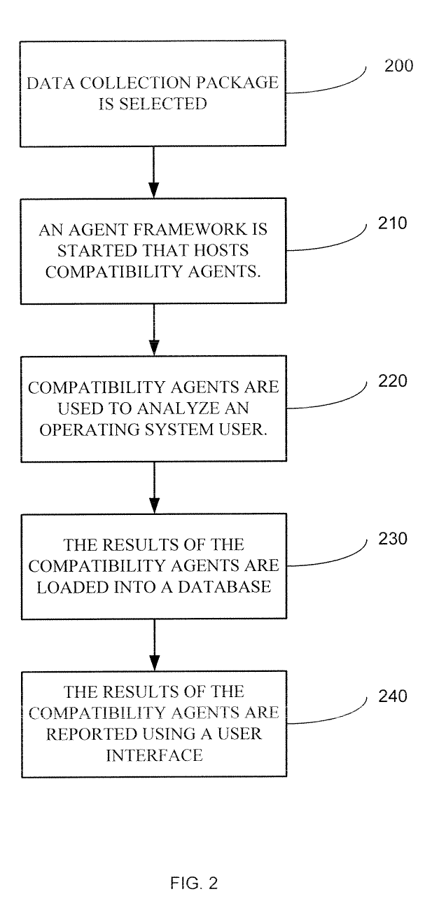

FIG. 2 is an illustration of a method of displaying the compatibility of an operating system user and an operating system. An operating system user may be an application, a computer, a website, an update, a device or any other user of the operating system. At a high level, the method may use agents that gather information about the users of an operating system. The gathered information is communicated to a database where additional operations may occur on the data.

At block 200, a data collection package may be created. The data collection package may be created by a user through a user interface. The data collection package may contain selected compatibility agents and setting related to the data collection package created.

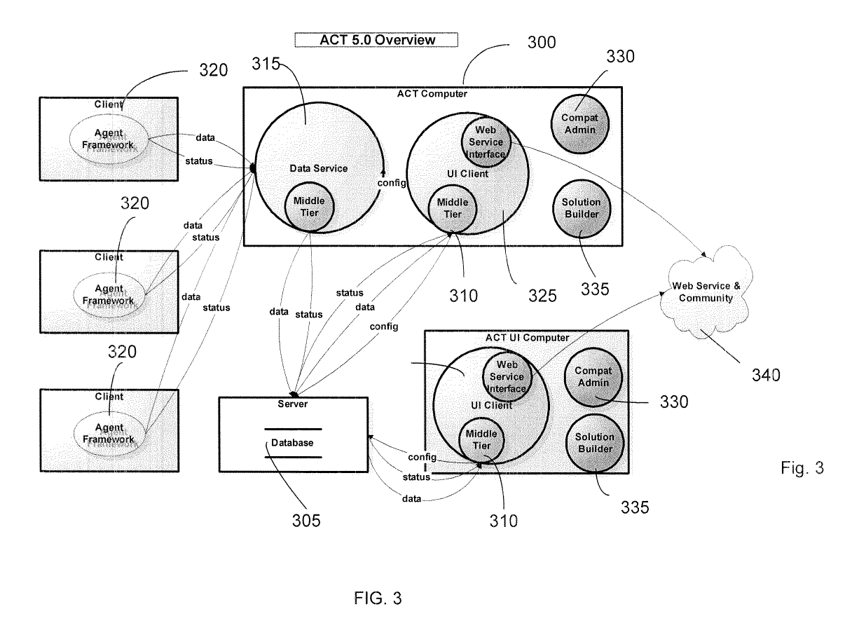

At block 210, an agent framework may be started that hosts compatibility agents. FIG. 3 is an illustration of a sample design of the components of a sample compatibility application 300. As can be seen from the diagram, the application 300 may be spread over numerous different computers. A database 305 may be stored in a server. In another embodiment, the database 305 is distributed across numerous storage devices. The database may store backend data, configuration data and status data related to the various installations of the compatibility application 300. The database 305 may be in communication with a middle tier 310. The middle tier 310 may be a layer that provides communication with the database 305. The communication may be wired, wireless or a combination of wired and wireless.

A log processing service 315 may collect data from agents and may communicate it into the database 305 through the middle tier 310. An agent framework 320 may host all the agents collecting compatibility data and it may upload data to the log processing service 315. The agent framework 320 may be installed in a plurality of computers and the computers may be geographically distributed. A user interface (“UI”) 325 may provide reports about the application 300, the configuration of the application 300 and the status of the application 300.

The application 300 may also provide a compatibility administrator application 330 and a solution builder application 335. The administrator application 330 may assist a central administrator monitor the various agent frameworks 320 installed. The solution builder 335 may assist in building solutions to compatibility problems that are found. A web service and community 340 may host application compatibility information and community services. In this way, solutions that have been created at one installation may be shared with multiple installations.

At block 220 (FIG. 2), compatibility agents are used to analyze an operating system user. As previously mentioned, the operating system user may be an application, computer, a website, an update, a device or any user of the operating system. In one embodiment, the compatibility agent is an agent that detects any applications that have user account control issues. In another embodiment, the compatibility agent is an internet browser evaluator that detects whether web sites and applications will have issues when used on a new internet browser. In another embodiment, the compatibility agent is an update impact monitor that detects whether there will be compatibility issues due to the installation of an operating system update. In yet another embodiment, the compatibility agent is a device compatibility evaluator that detects whether there will be compatibility issues related to devices based on the drivers used on the devices. Of course, other embodiments are possible and are contemplated.

A data collect package may be used to distribute the agents. The data collection package may include a common framework service to schedule and manage the agents. The data collection package may be entirely self managed.

At block 230, the results of the compatibility agents may be communicated to a database 305 (FIG. 3). As explained with reference to FIG. 3, there may be a variety of ways to communicate the data to the database 305. In one embodiment, the agent framework 320 may upload the data to a log share and a log processing service may process this data in the database 305. In another embodiment, a middle tier 310 is used to provide communication between the database 305 and the log processing service 315.

At block 240, the results of the compatibility agents may be reported using a user interface. The user interface may report all inventoried operating system users such as applications, computers, web sites, devices, and updates and whether there are compatibility issues with any of the operating system users.

In addition, reports may be generated such as a report that lists which computer meets the minimum recommended system requirements to run certain applications, such as an operating system or a word processor. The reports may also list applications potentially impacted by an update, such as an update to an operating system.

The user interface may also permit a selection to fix the compatibility issues. This assumes a fix is known and is available. The user interface may also allow a user to connect to a community 340 to access compatibility and fix information. For example, a first user may have determined a solution to a tricky compatibility question and this solution may be useful to others.

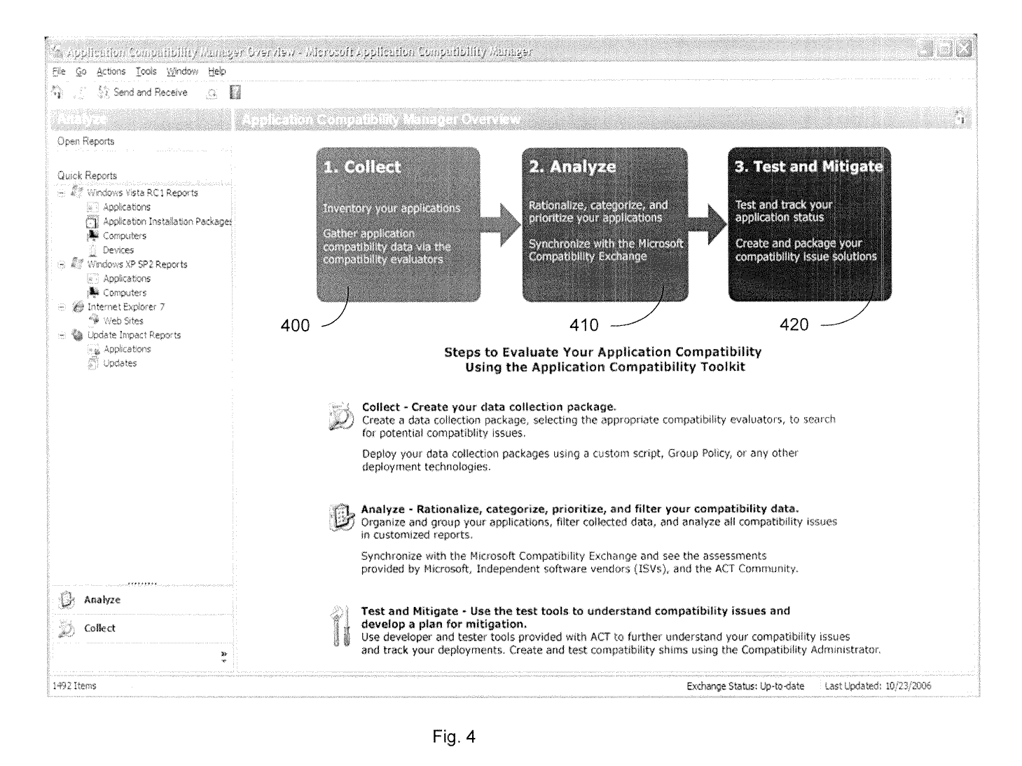

Referring to FIG. 4, a user may be presented a high level illustration of how the application 300 will operate. In general, three steps will occur. A block 400, data will be collected. At block 410, the data will be analyzed to determine known compatibility issues. At block 420, tests may be run to determine the best way to address and mitigate potential compatibility problems.

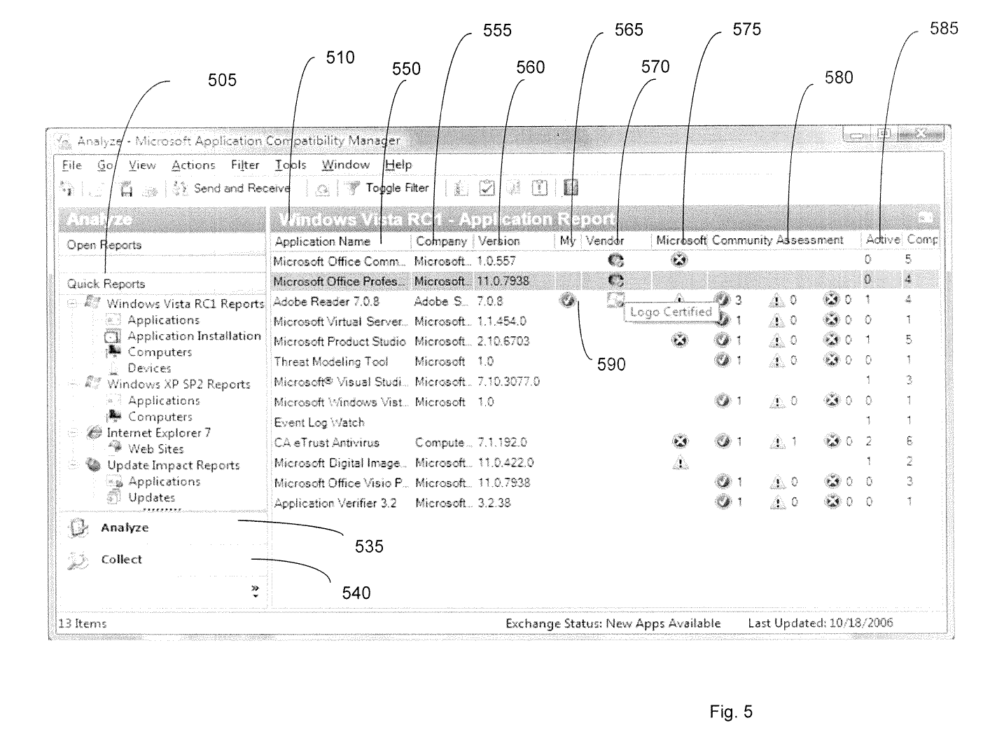

Referring to FIG. 5, a sample application report is illustrated. In a column 505, a list of available quick reports is present. By selecting a report in the column 505, an expand view of the selected report may be displayed in another portion 510 of the display. The various reports may be specific to the various operating systems that may be present on a network such as Windows Vista 515 or Windows XP 520 or under the sphere of influence of an administrator. Other reports may examine web browsers 525 and updates 530. In addition, a user may be presented the option to start an analysis 535 of data already in a system or collect data 540 from computers on a network or under the sphere of influence of an administrator.

In the expanded view 510, a detailed list related to the selection made in column 505 is displayed. In FIG. 5, Windows Vista applications 515 was selected and the compatibility details relate to applications operating under Windows Vista. Sample headings in the report include application name 550, the company that created the application 555, the version of the application 560, the My Assessment which is a user's own assessment of the application 565, whether the vendor is a certified vendor 570, whether Microsoft knows of any compatibility problems 575, whether the user community knows of any problems 580, the compatibility problem column may be removed and may be part of the user community with Microsoft Testing being one of the sub-providers in the community. The compatibility may be indicated using a symbol 590. The symbols 590 may include a green “check” to indicate that compatibility is fine, a yellow triangle with an “!” to indicate that there may be minor compatibility issues with the application, device, web site, etc and a red circle with an “x” may indicate that compatibility issue are known. Of course, other relevant headings are possible and are contemplated.

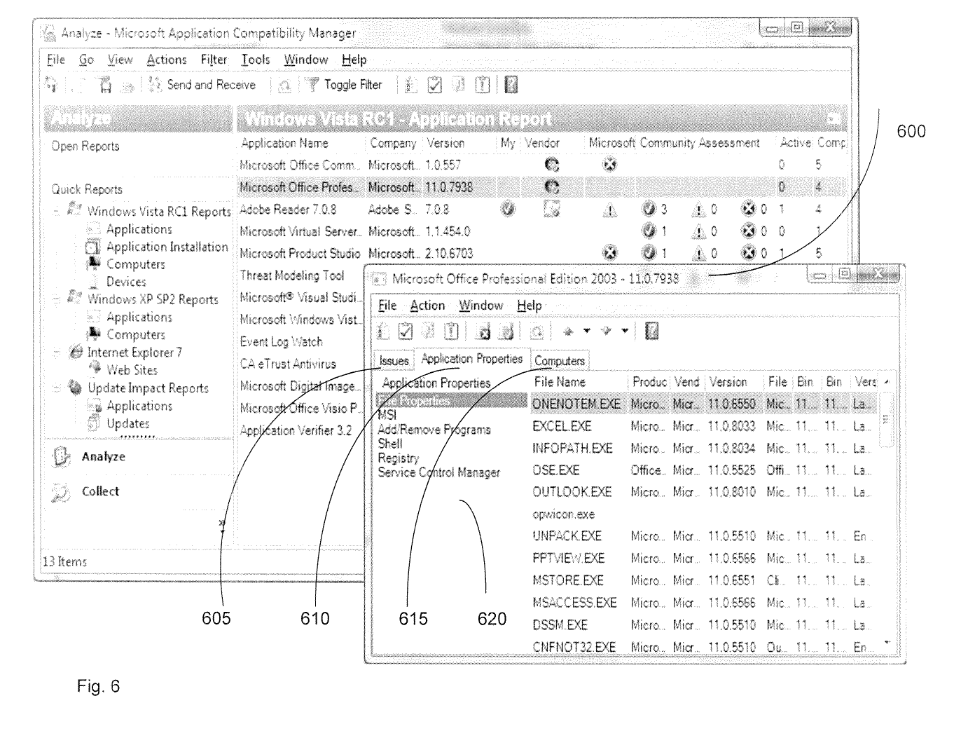

By selecting a specific application in FIG. 5, an additional window 600 such as the window displayed in FIG. 6 may be displayed 600 that provides additional detail about the selected application. One tab may display information about known issues 605 with the selected application, another tab may display information about application properties 610 and a further tab may display details 615 about computers that have the selected application installed. Under each tab 605, 610 and 615, additional relevant information may be displayed along with a list of options that may be pursued 620.

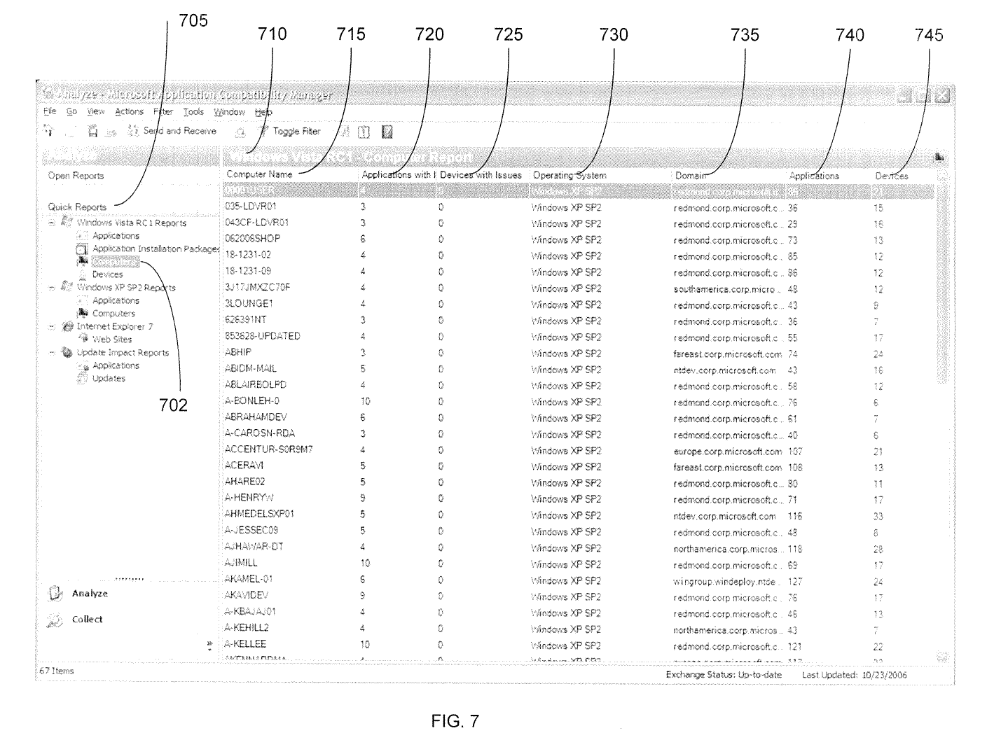

FIG. 7 is an illustration of a display when a computer tab 702 is selected from the quick report section 705. At a higher level, the compatibility analysis application may be distributed across a network and information about all the computers on the network or multiple networks may be obtained. FIG. 7 is an illustration of the display that may be created using the collected data.

In the larger detail area 710, a report on the various computers that are under the sphere of review of the administrator is displayed. Tabs may be displayed that list a computer name 715, a number of applications with compatibility issues 720, a number of devices with compatibility issues 725, an identification of an operating system 730 used on the computer, a domain 735 of the computer, a number of applications 740 that are running and a number of devices 745 that are operating. In addition, each of the individual computers under the computer tab 715 may be selected and additional information may be displayed about the selected computer.

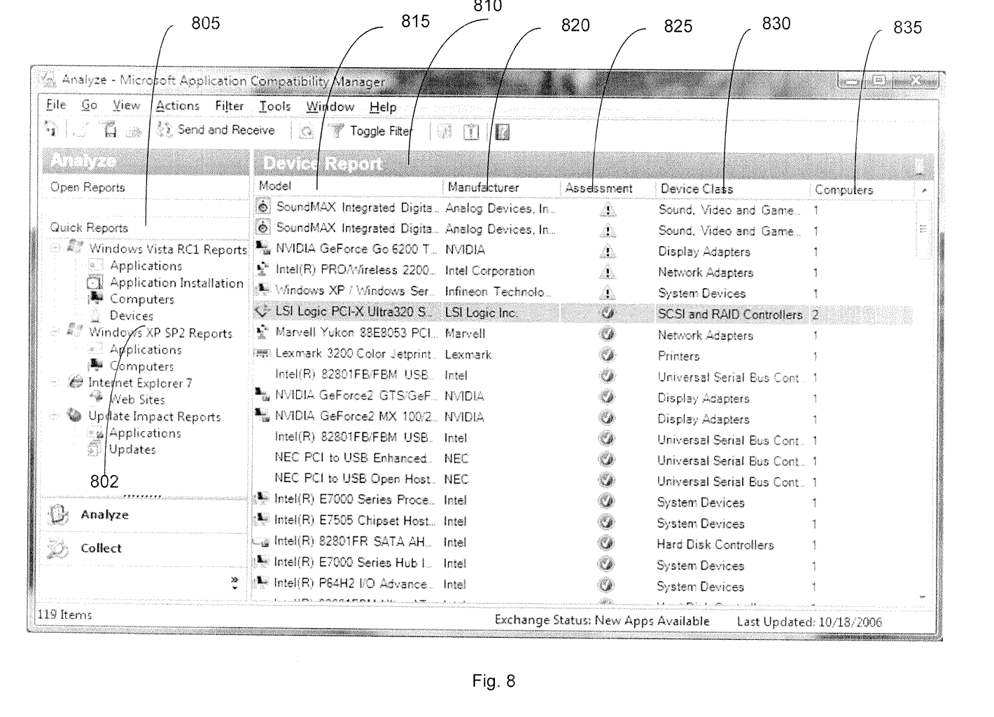

FIG. 8 is an illustration of a display when a device tab 802 is selected from the quick report section 805. At a higher level, the compatibility analysis application may be distributed across a network and information about all the devices on the network or on multiple networks may be obtained. FIG. 8 is an illustration of the display that may be created using the collected device data.

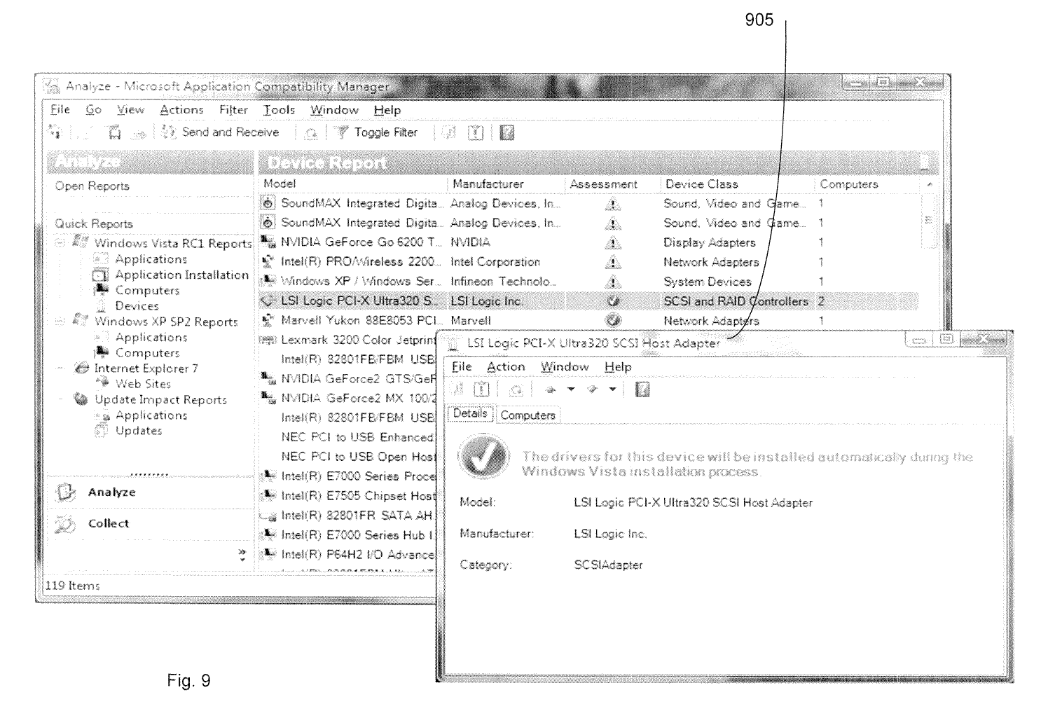

In the larger area of the display 810, a report on the various devices that are under the sphere of review of the administrator is displayed. Tabs may be displayed that list a model name 815, a manufacturer 820, an assessment 825, a device class 830 and a number 835 of computers that are able to use the device. Under the assessment tab 825, a symbol may provide a quick visual indication of the compatibility status of the device. In addition, each device may be selected and additional information may be displayed about the selected device. There may also be links to additional information about the device status which take the user to Windows Update or Vendor product sites for example. FIG. 9 is an illustration of a display when a particular device from FIG. 8 is selected. A separate window 905 may be displayed that provides additional details about the selected device.

Additional displays are possible and are contemplated. For example, compatibility issues may be added and a window may be displayed that makes adding the compatibility issues easy. Another example is a window that is displayed when compatibility solutions are added. Another possible window is for prioritizing applications, devices or computers. An additional window may be displayed is a window for categorizing applications, device and computers. Finally, reports may be designed to display virtually any of the data in a manner desired by a user. The data may be filtered and displayed in virtually any manner desired by a user. Truly, the amount and variety of reports is virtually limitless.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patents which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of displaying the compatibility of an operating system user and an operating system comprising:
creating a data collection package to distribute compatibility agents;
starting an agent framework that host compatibility agents;
using compatibility agents to analyze an operating system user;
communicating results of the compatibility agents to a database; and
displaying the results of the compatibility agents using a user interface.

2. The method of claim 1, further comprising synchronizing with a remote data source to obtain updated compatibility information.

3. The method of claim 2, wherein the compatibility information is provided by at least one of: original software makers, third party vendors, users and other trusted parties.

4. The method of claim 1, wherein the operating system user is one of an application, computer, a website, an update, and a device.

5. The method of claim 1, wherein the compatibility agents further comprise an agent that detects any applications that have user account control issues.

6. The method of claim 1, wherein the compatibility agents further comprise an internet browser evaluator that detects whether web sites and applications will have issues when used on a new internet browser.

7. The method of claim 1, wherein the compatibility agents further comprises an update impact monitor that detects whether there will be compatibility issues due to the installation of an operating system update.

8. The method of claim 1, wherein the compatibility agents further comprises a device compatibility evaluator that detects whether there will be compatibility issues related to devices based on the drivers used on the devices.

9. The method of claim 1, wherein the data collection package further comprises a common framework service to schedule and manage the agents.

10. The method of claim 1, wherein the user interface reports all inventoried applications, computers, web sites, devices, and updates and whether there are compatibility issues with any of the above.

11. The method of claim 1, wherein a selection is made of one of the applications, computers, web sites, devices and updates and additional information is displayed about the selection.

12. The method of claim 1, wherein symbols are used to display the compatibility of the all inventoried applications, computers, web sites, devices, and updates.

13. The method of claim 1, further comprising displaying reports which identify a computer that meets the minimum recommended system requirements to run the operating system.

14. The method of claim 1, further comprising displaying reports on applications potentially impacted by an operating system update.

15. The method of claim 1, further comprising allowing a selection to attempt to fix the compatibility issues.

16. A user interface for displaying the compatibility of operating system users and an operating system comprising:
a first window for displaying a plurality of quick compatibility reports that are available related to operating system users wherein the operating system users are selectable;
a second window for displaying additional information about operating system users wherein the additional information includes compatibility information wherein the additional information is selectable; and
a third window that is displayed when additional information is selected that provides further detail about the additional information that is selected.

17. The user interface of claim 16, wherein the compatibility reports are created by:
starting an agent framework that host compatibility agents;
using compatibility agents to analyze an operating system user;
communicating results of the compatibility agents to a database; and
accessing the database to create the compatibility data that is displayed on the user interface.

18. The user interface of claim 16, wherein the compatibility agents further comprise at least one selected from the group comprising:
an agent that detects any applications that have user account control issues;
an internet browser evaluator that detects whether web sites and applications will have issues when used on a new internet browser;
an update impact monitor that detects whether there will be compatibility issues due to the installation of an operating system update; and
a device compatibility evaluator that detects whether there will be compatibility issues related to devices based on the drivers used on the devices.

19. A computer readable storage medium for storing computer executable code, the computer executable code comprising computer executable instruction for:
starting an agent framework that host compatibility agents;
using compatibility agents to analyze an operating system user, wherein the compatibility agents further comprise at least one selected from the group comprising:
an agent that detects any applications that have user account control issues;
an internet browser evaluator that detects whether web sites and applications will have issues when used on a new internet browser;
an update impact monitor that detects whether there will be compatibility issues due to the installation of an operating system update; and
a device compatibility evaluator that detects whether there will be compatibility issues related to devices based on the drivers used on the devices communicating results of the compatibility agents to a database; and
displaying the results of the compatibility agents using a user interface.

20. A computer readable storage medium of claim 19, wherein the user interface further comprises at least one from the group comprising:
a window for displacing a plurality of quick compatibility reports that are available related to operating system users wherein the operating system users are selectable;
a window for displaying additional information about operating system users wherein the additional information includes compatibility information wherein the additional information is selectable;
a window that is displayed when additional information is selected that provides further detail about the additional information that is selected;
a window that is displayed when adding compatibility issues;
a window that is displayed when adding solutions to compatibility issues;
a window that is displayed for prioritizing at least one selected from the group comprising applications, devices and computers;
a window that is displayed for categorizing at least one selected from the group comprising applications, device and computers; and
a window that is displayed for designing a new report.
